(19) United States
(12) Patent Application Publication
(10) Pub. No.: US 2008/0147767 A1
(43) Pub. Date: Jun. 19, 2008

(54) BINOMIAL OPTIONS PRICING MODEL COMPUTATIONS USING A PARALLEL PROCESSOR

(75) Inventor: Scott Le Grand, Soquel, CA (US)

Correspondence Address: TOWNSEND AND TOWNSEND AND CREW LLP, TWO EMBARCADERO CENTER, 8TH FLOOR, SAN FRANCISCO, CA, 94111-3834, US

(73) Assignee: NVIDIA Corporation, Santa Clara, CA (US)

(21) Appl. No.: 11/610,373

(22) Filed: Dec. 13, 2006

(51) Int. Cl. G06F 7/38

(52) U.S. Cl. 708/490

(57) ABSTRACT

Binomial options pricing model computations are performed on node values of a lattice using a parallel processor such as a single-instruction, multiple-data processor. The parallel processor stores computational data in on-chip memory. Data to be processed by a group of threads executing the binomial options pricing model computations is read from the external memory in swaths and stored in a first on-chip memory, while a copy of data to be processed at a later time by the group of threads is stored in a second on-chip memory. Data in the first on-chip memory is processed for multiple time steps before being written to the external memory. Processing data multiple times and keeping a copy of data for later use reduces the amount of data to be retrieved from memory, thereby improving computational efficiency.

### BACKGROUND OF THE INVENTION

The present invention relates generally to graphics processors and more particularly to performing binomial options pricing model computations using graphics processors.

The demand for increased realism in computer graphics for games and other applications has been steady for some time now and shows no signs of abating. This has placed stringent performance requirements on computer system components, particularly graphics processors. For example, to generate improved images, an ever increasing amount of data needs to be processed by a graphics processing unit. In fact, so much graphics data now needs to be processed that conventional techniques are not up to the task and need to be replaced.

A new type of parallel processing circuit has been developed that is capable of meeting these demands. This circuit is based on the concept of multiple single-instruction, multiple-data processors. These new processors are capable of simultaneously executing hundreds of processes. These new processors are so powerful that they are being put to use for other functions beyond their traditional realm of graphics processing. These functions include tasks that are normally executed by a central processing unit. By taking over these functions, the work load on the central processing unit is reduced, improving system performance. This also allows a slower, less-expensive central processing unit to be used.

Computations are one type of function that are now being performed by these new graphics processors. These computations may become particularly intensive when they involve lattices or matrices of data. These situations require the storage of large amounts of data. Unfortunately, memory is very expensive to include on a graphics processor. This is partly because the processing steps that are used to manufacture efficient, low cost memory are not compatible with processes used for graphics processors. Accordingly, most data used by a graphics processor is stored externally. But access to an off-chip memory is slow; the latency involved in reading data may be hundreds of clock cycles. This latency reduces the computational efficiency of the graphics processor.

Thus, there is a need for a graphics or other processor to perform computations involving large amounts of data while reducing the amount of data read from an external memory.

### BRIEF SUMMARY OF THE INVENTION

Accordingly, embodiments of the present invention reduce the amount of data read from an external memory by a graphics or other type of processor when performing binomial options pricing model computations on large sets of data.

An exemplary embodiment of the present invention performs binomial options pricing model computations to compute a lattice of node values using a parallel processor such as a single-instruction, multiple-data processor. The parallel processor reads the node values in swaths from external memory and stores computational data in on-chip memory referred to as a global register file and a local register file. Node values corresponding to the results of the binomial options pricing model computations are written to an external memory after multiple time step computations, but some of the node values that are used in subsequent binomial options pricing model computations are stored in the on-chip memory. Performing multiple time steps while the data is on-chip and storing the shared node values for future use in the on-chip memory reduces the amount of data to be retrieved from and written to the lattice in external memory, thereby improving computational efficiency.

In this embodiment of the present invention, a first set of data is initially read in swaths from an external memory, which may be referred to as a global memory, and stored in the global register file. A copy of a portion of the first set of data that may be useful at a later time is cached in the local register file. For example, a copy of a portion that is common to a first set and a second set of data is cached in the local register file. Binomial options pricing model computations are performed for multiple time steps on the first set of data in the global register file. When complete, results are written to the external memory. To reduce the number of times results are written to the external memory, the binomial options pricing model computations are performed on the first set of data multiple times before results are written. The portion of the first set of data cached in the local register file can then be read and stored in the global register file, that is, the data common to the first and second sets can be transferred to the global register file. Other data that is needed for a second set of data is read from the external memory and stored in the global register file, and this data, along with the previously cached data, is processed by performing the binomial options pricing model computations, again multiple times.

Another exemplary embodiment of the present invention performs binomial options pricing model computations on a data set that includes a matrix or lattice of data. The lattice may be too large for the computations to be completed at one time. Accordingly, the binomial options pricing model computations are performed on swaths of node values read from the lattice. When multiple time step computations on one swath are being performed, intermediate data is stored in an on-chip global register file. When complete, this data is written out to an external memory. The cached data from the local register file is read. New data is read from the external memory. This data from the shared register file and from the external memory is written to the global register file and used when performing the binomial options pricing model computations on a next swath of lattice data.

Another exemplary embodiment of the present invention executes a number of cooperative thread arrays on a number of SIMD processors. Each CTA is responsible for computations of one swath of data in a portion of a lattice. The swath may vertically or horizontally traverse the portion of the lattice. For each CTA, data is read for a first swath and stored in a global register file. To save memory bandwidth, data that can be used by the CTA in processing a second, adjacent swath is stored in a local register file. Binomial options pricing model computations are performed on nodes of the swath in a number of iterations to save memory bandwidth. When processing is complete on the first swath, data is read out to memory. The data saved in the local register file is read. The remaining data for the second, adjacent swath is read from an external memory, and the CTA resumes processing.

Various embodiments of the present invention may incorporate one or more of these or the other features described herein. A better understanding of the nature and advantages of the present invention may be gained with reference to the following detailed description and the accompanying drawings.

### BRIEF DESCRIPTION OF THE DRAWINGS

FIG. 1 is a block diagram of a computing system that is improved by incorporating an embodiment of the present invention;

FIG. 2 is a block diagram of a parallel processing unit according to an embodiment of the present invention;

FIG. 3 illustrates portions of a lattice of data on which binomial options pricing model computations are performed according to an embodiment of the present invention; and

FIG. 4 illustrates a method for performing binomial options pricing model computations on a lattice of data according to an embodiment of the present invention.

### DETAILED DESCRIPTION OF THE INVENTION

### System Overview

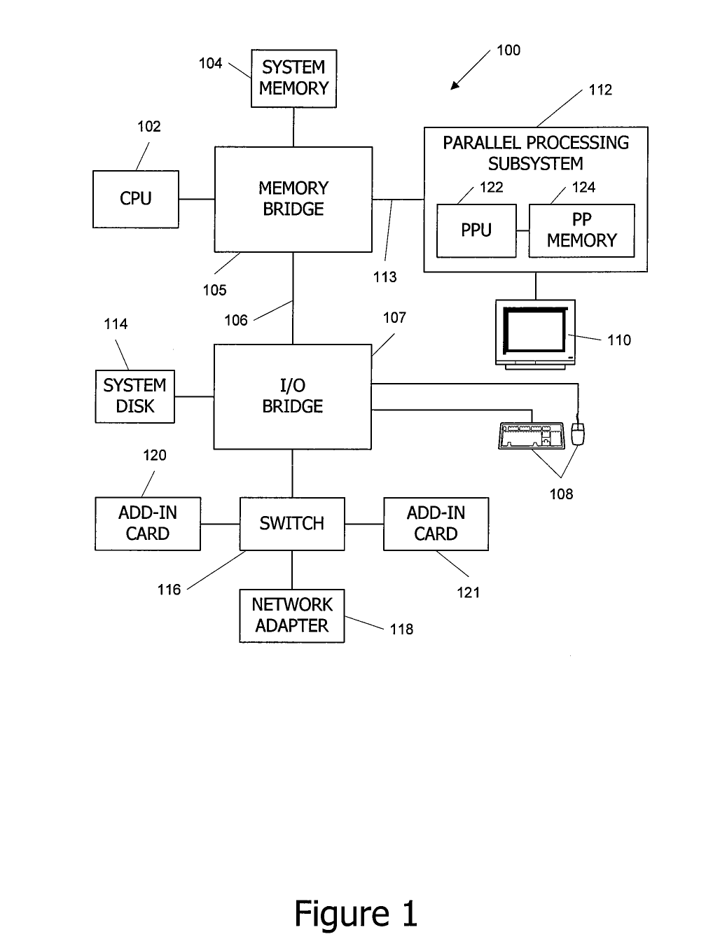

FIG. 1 is a block diagram of a computer system 100 according to an embodiment of the present invention. Computer system 100 includes a central processing unit (CPU) 102 and a system memory 104 communicating via a bus path that includes a memory bridge 105. Memory bridge 105, which may be, e.g., a Northbridge chip, is connected via a bus or other communication path 106 (e.g., a HyperTransport link) to an I/O (input/output) bridge 107. I/O bridge 107, which may be, e.g., a Southbridge chip, receives user input from one or more user input devices 108 (e.g., keyboard, mouse) and forwards the input to CPU 102 via path 106 and memory bridge 105. A parallel processing subsystem 112 is coupled to memory bridge 105 via a bus or other communication path 113 (e.g., a PCI Express or Accelerated Graphics Port link); in one embodiment parallel processing subsystem 112 is a graphics subsystem that delivers pixels to a display device 110 (e.g., a conventional CRT or LCD based monitor). A system disk 114 is also connected to I/O bridge 107. A switch 116 provides connections between I/O bridge 107 and other components such as a network adapter 118 and various add-in cards 120 and 121. Other components (not explicitly shown), including USB or other port connections, CD drives, DVD drives, and the like, may also be connected to I/O bridge 107. Communication paths interconnecting the various components in FIG. 1 may be implemented using any suitable protocols, such as PCI (Peripheral Component Interconnect), PCI Express (PCI-E), AGP (Accelerated Graphics Port), Hypertransport, or any other bus or point-to-point communication protocol(s), and connections between different devices may use different protocols as is known in the art.

Parallel processing subsystem 112 includes a parallel processing unit (PPU) 122 and a parallel processing (PP) memory 124, which may be implemented, e.g., using one or more integrated circuit devices such as programmable processors, application specific integrated circuits (ASICs), and memory devices. PPU 122 advantageously implements a highly parallel processor including one or more processing cores, each of which is capable of executing a large number (e.g., hundreds or thousands) of threads concurrently. PPU 122 can be programmed to perform a wide array of computations, including linear and nonlinear data transforms, filtering of video and/or audio data, modeling (e.g., applying laws of physics to determine position, velocity and other attributes of objects), image rendering, and so on. PPU 122 may transfer data from system memory 104 and/or PP memory 124 into internal memory, process the data, and write result data back to system memory 104 and/or PP memory 124, where such data can be accessed by other system components, including, e.g., CPU 102. In some embodiments, PPU 122 is a graphics processor that can also be configured to perform various tasks related to generating pixel data from graphics data supplied by CPU 102 and/or system memory 104 via memory bridge 105 and bus 113, interacting with PP memory 124 (which can be used as graphics memory including, e.g., a conventional frame buffer) to store and update pixel data, delivering pixel data to display device 110, and the like. In some embodiments, PP subsystem 112 may include one PPU 122 operating as a graphics processor and another PPU 122 used for general-purpose computations. The PPUs may be identical or different, and each PPU may have its own dedicated PP memory device(s).

CPU 102 operates as the master processor of system 100, controlling and coordinating operations of other system components. In particular, CPU 102 issues commands that control the operation of PPU 122. In some embodiments, CPU 102 writes a stream of commands for PPU 122 to a command buffer, which may be in system memory 104, PP memory 124, or another storage location accessible to both CPU 102 and PPU 122. PPU 122 reads the command stream from the command buffer and executes commands asynchronously with operation of CPU 102.

It will be appreciated that the system shown herein is illustrative and that variations and modifications are possible. The connection topology, including the number and arrangement of bridges, may be modified as desired. For instance, in some embodiments, system memory 104 is connected to CPU 102 directly rather than through a bridge, and other devices communicate with system memory 104 via memory bridge 105 and CPU 102. In other alternative topologies, PP subsystem 112 is connected to I/O bridge 107 rather than to memory bridge 105. In still other embodiments, I/O bridge 107 and memory bridge 105 might be integrated into a single chip. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

The connection of PPU 122 to the rest of system 100 may also be varied. In some embodiments, PP system 112 is implemented as an add-in card that can be inserted into an expansion slot of system 100. In other embodiments, a PPU can be integrated on a single chip with a bus bridge, such as memory bridge 105 or I/O bridge 107. In still other embodiments, some or all elements of PPU 122 may be integrated with CPU 102.

A PPU may be provided with any amount of local PP memory, including no local memory, and may use local memory and system memory in any combination. For instance, PPU 122 can be a graphics processor in a unified memory architecture (UMA) embodiment; in such embodiments, little or no dedicated graphics memory is provided, and PPU 122 would use system memory exclusively or almost exclusively. In UMA embodiments, the PPU may be integrated into a bridge chip or provided as a discrete chip with a high-speed link (e.g., PCI-E) connecting the GPU to the bridge chip and system memory.

It is also to be understood that any number of PPUs may be included in a system, e.g., by including multiple PPUs on a single add-in card, by connecting multiple add-in cards to path 113, and/or by connecting one or more PPUs directly to a system motherboard. Multiple PPUs may be operated in parallel to process data at higher throughput than is possible with a single PPU.

Systems incorporating PPUs may be implemented in a variety of configurations and form factors, including desktop, laptop, or handheld personal computers, servers, workstations, game consoles, embedded systems, and so on.

### Core Architecture

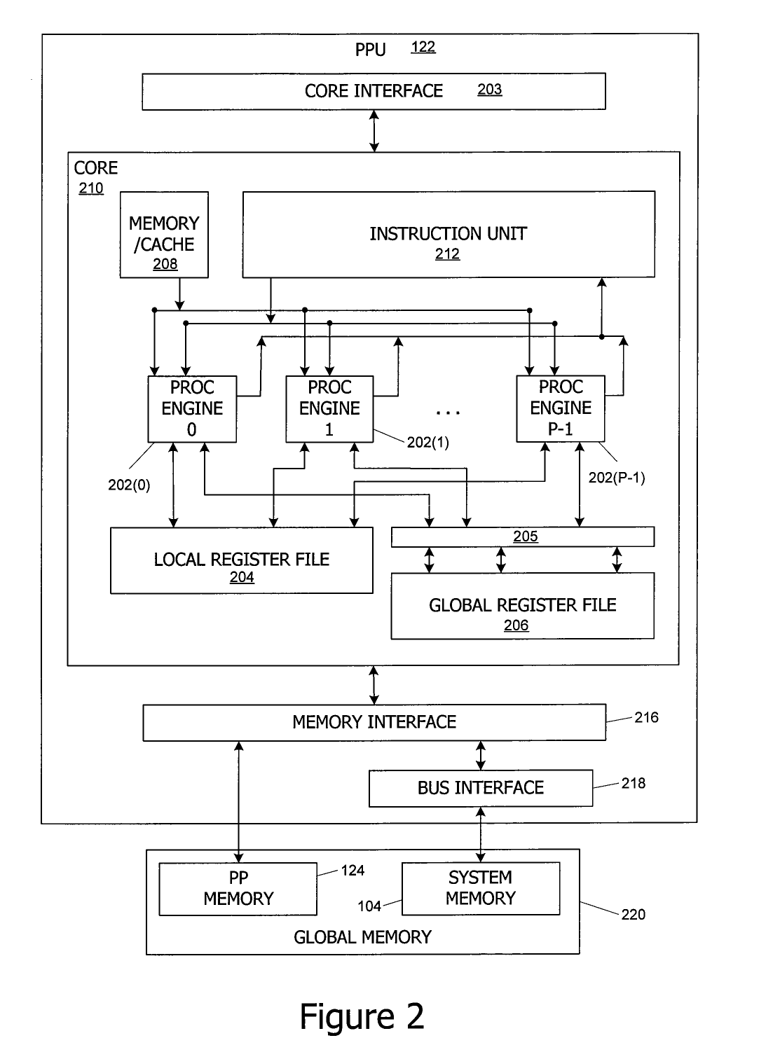

FIG. 2 is a block diagram of a PPU 122 usable in an embodiment of the present invention. PPU 122 includes a core 210 configured to execute a large number of threads in parallel, where the term “thread” refers to an instance of a particular program executing on a particular set of input data. In some embodiments, single-instruction, multiple-data (SIMD) instruction issue techniques are used to support parallel execution of a large number of threads without providing multiple independent instruction units.

In one embodiment, core 210 includes an array of P (e.g., 8, 16, etc.) parallel processing engines 202 configured to receive SIMD instructions from a single instruction unit 212. Each processing engine 202 advantageously includes an identical set of functional units (e.g., arithmetic logic units, etc.). The functional units may be pipelined, allowing a new instruction to be issued before a previous instruction has finished, as is known in the art. Any combination of functional units may be provided. In one embodiment, the functional units support a variety of operations including integer and floating point arithmetic (e.g., addition and multiplication), comparison operations, Boolean operations (AND, OR, XOR), bit-shifting, and computation of various algebraic functions (e.g., planar interpolation, trigonometric, exponential, and logarithmic functions, etc.); and the same functional-unit hardware can be leveraged to perform different operations.

Each processing engine 202 uses space in a local register file (LRF) 204 for storing its local input data, intermediate results, and the like. In one embodiment, local register file 204 is physically or logically divided into P lanes, each having some number of entries (where each entry might store, e.g., a 32-bit word). One lane is assigned to each processing engine 202, and corresponding entries in different lanes can be populated with data for different threads executing the same program to facilitate SIMD execution. In some embodiments, each processing engine 202 can only access LRF entries in the lane assigned to it. The total number of entries in local register file 204 is advantageously large enough to support multiple concurrent threads per processing engine 202.

Each processing engine 202 also has access to an on-chip shared memory 206 that is shared among all of the processing engines 202 in core 210. Shared memory 206 may be as large as desired, and in some embodiments, any processing engine 202 can read to or write from any location in shared memory 206 with equally low latency (e.g., comparable to accessing local register file 204). In some embodiments, shared memory 206 can be implemented using shared cache memory, addressable SRAM, or other conventional memory technologies.

In addition to shared memory 206, some embodiments also provide additional on-chip parameter memory and/or cache(s) 208, which may be implemented, e.g., as a conventional RAM or cache. Parameter memory/cache 208 can be used, e.g., to hold state parameters and/or other data (e.g., textures or primitives for a shader program) that may be needed by multiple threads. Processing engines 202 also have access via a memory interface 216 to additional off-chip global memory 220, which includes, e.g., PP memory 124 and/or system memory 104, with system memory 104 being accessible by memory interface 216 via a bus interface 218; it is to be understood that any memory external to PPU 122 may be used as global memory 220. Memory interface 216 and bus interface 218 may be of generally conventional design, and other appropriate interfaces may be substituted. Processing engines 202 are advantageously coupled to memory interface 216 via an interconnect (not explicitly shown) that allows any processing engine 202 to access global memory 220.

In one embodiment, each processing engine 202 is multithreaded and can execute up to some number G (e.g., 24) of threads concurrently, e.g., by maintaining current state information associated with each thread in a different portion of its assigned lane in local register file 204. Processing engines 202 are advantageously designed to switch rapidly from one thread to another so that instructions from different threads can be issued in any sequence without loss of efficiency.

Instruction unit 212 is configured such that, for any given processing cycle, the same instruction (INSTR) is issued to all P processing engines 202. Thus, at the level of a single clock cycle, core 210 implements a P-way SIMD microarchitecture. Since each processing engine 202 is also multithreaded, supporting up to G threads, core 210 in this embodiment can have up to P*G threads executing concurrently. For instance, if P=16 and G=24, then core 210 supports up to 384 concurrent threads.

Because instruction unit 212 issues the same instruction to all P processing engines 202 in parallel, core 210 is advantageously used to process threads in “SIMD groups.” As used herein, a “SIMD group” refers to a group of up to P threads of execution of the same program on different input data, with one thread of the group being assigned to each processing engine 202. (A SIMD group may include fewer than P threads, in which case some of processing engines 202 will be idle during cycles when that SIMD group is being processed.) Since each processing engine 202 can support up to G threads, it follows that up to G SIMD groups can be executing in core 210 at any given time.

On each clock cycle, one instruction is issued to all P threads making up a selected one of the G SIMD groups. To indicate which thread is currently active, a “group index” (GID) for the associated thread may be included with the instruction. Processing engine 202 uses group index GID as a context identifier, e.g., to determine which portion of its assigned lane in local register file 204 should be used when executing the instruction. Thus, in a given cycle, all processing engines 202 in core 210 are nominally executing the same instruction for different threads in the same group. (In some instances, some threads in a group may be temporarily idle, e.g., due to conditional or predicated instructions, divergence at branches in the program, or the like.)

Operation of core 210 is advantageously controlled via a core interface 203. In some embodiments, core interface 203 receives data to be processed (e.g., vertex data and/or pixel data) as well as state parameters and commands defining how the data is to be processed (e.g., what program is to be executed). Core interface 203 can load data to be processed into shared memory 206 and parameters into parameter memory 208. Core interface 203 also initializes each new thread or SIMD group in instruction unit 212, then signals instruction unit 212 to begin executing the threads. When execution of a thread or SIMD group is completed, core 210 advantageously notifies core interface 203. Core interface 203 can then initiate other processes, e.g., to retrieve output data from shared memory 206 and/or to prepare core 210 for execution of additional threads.

It will be appreciated that the core architecture described herein is illustrative and that variations and modifications are possible. Any number of processing engines may be included. In some embodiments, each processing engine has its own local register file, and the allocation of local register file entries per thread can be fixed or configurable as desired. Further, while only one core 210 is shown, a PPU 122 may include any number of cores 210, with appropriate work distribution logic to distribute incoming processing tasks among the available cores 210, further increasing the processing capacity. Each core 210 advantageously operates independently of other cores 210 and has its own processing engines, shared memory, and so on. Where multiple cores 210 are present, PPU 122 may include a work distribution unit (not explicitly shown) that distributes processing tasks among the available cores.

### Cooperative Thread Arrays

Embodiments of multithreaded processing core 210 of FIG. 2 can execute general-purpose computations using cooperative thread arrays (CTAs). As used herein, a “CTA” is a group of multiple threads that concurrently execute the same program on an input data set to produce an output data set. Each thread in the CTA is assigned a unique thread identifier (“thread ID”) that is accessible to the thread during its execution. The thread ID controls various aspects of the thread's processing behavior. For instance, a thread ID may be used to determine which portion of the input data set a thread is to process, to identify one or more other threads with which a given thread is to share an intermediate result, and/or to determine which portion of an output data set a thread is to produce or write.

CTAs are advantageously employed to perform computations that lend themselves to a data parallel decomposition, i.e., application of the same processing algorithm to different portions of an input data set in order to effect a transformation of the input data set to an output data set. Examples include matrix algebra, linear and/or nonlinear transforms in any number of dimensions (e.g., fast Fourier transforms), various filtering algorithms, lattice-based computations such as binomial options pricing model computations, and so on. The processing algorithm to be applied to each portion of the input data set is specified in a “CTA program,” and each thread in a CTA executes the same CTA program on one portion of the input data set. A CTA program can implement algorithms using a wide range of mathematical and logical operations, and the program can include conditional or branching execution paths and direct and/or indirect memory access.

Threads in a CTA can share input data, processing parameters, and/or intermediate results with other threads in the same CTA using shared memory 206. In some embodiments, a CTA program includes an instruction to compute an address in shared memory 206 to which particular data is to be written, with the address being a function of thread ID. Each thread computes the function using its own thread ID and writes to the corresponding location. The address function is advantageously defined such that different threads write to different locations; as long as the function is deterministic, the location written to by any thread is predictable. The CTA program can also include an instruction to compute an address in shared memory 206 from which data is to be read, with the address being a function of thread ID. By defining suitable functions and providing synchronization techniques, data can be written to a given location in shared memory 206 by one thread and read from that location by a different thread in a predictable manner. Consequently, any desired pattern of data sharing among threads can be supported, and any thread in a CTA can share data with any other thread in the same CTA.

Since all threads in a CTA execute the same program, any thread can be assigned any thread ID, as long as each valid thread ID is assigned to only one thread. In one embodiment, thread IDs are assigned sequentially to threads as they are launched. It should be noted that as long as data sharing is controlled by reference to thread IDs, the particular assignment of threads to processing engines will not affect the result of the CTA execution. Thus, a CTA program can be independent of the particular hardware on which it is to be executed.

Any unique identifier (including but not limited to numeric identifiers) can be used as a thread ID. In one embodiment, if a CTA includes some number (T) of threads, thread IDs are simply sequential (one-dimensional) index values from 0 to T−1. In other embodiments, multidimensional indexing schemes can be used.

In addition to thread IDs, some embodiments also provide a CTA identifier that is common to all threads in the CTA. CTA identifiers can be helpful, e.g., where an input data set is to be processed using multiple CTAs that process different (possibly overlapping) portions of an input data set. The CTA identifier may be stored in a local register of each thread, in a state register accessible to all threads of the CTA, or in other storage accessible to the threads of the CTA. While all threads within a CTA are executed concurrently, there is no requirement that different CTAs are executed concurrently, and the hardware need not support sharing of data between threads in different CTAs.

It will be appreciated that the size (number of threads) of a CTA and number of CTAs required for a particular application will depend on the application. Thus, the size of a CTA, as well as the number of CTAs to be executed, are advantageously defined by a programmer or driver program and provided to core 210 and core interface 203 as state parameters.

Memory/cache 208, global register file 206, and local register file 204, are formed on an integrated circuit that also includes instruction unit 212, processing engines 202, crossbar 205, memory interface 216, and other circuitry. Global memory 220 is typically not included on this chip. Presently, this is because global memory 220 is most efficiently manufactured using one of a number of highly specialized processes developed for this purpose. The other circuits, such as processing engines 202 and global register file 206, are manufactured using another type of process that is incompatible with the process used to manufacture global memory 220. This different processing leads to PPU 122 and global memory 220 being most efficiently fabricated on two different integrated circuits. In the future, some or all of global memory 220 may be included on an integrated circuit with processing engines 202 and global register file 206 in a manner consistent with an embodiment of the present invention.

Since global memory 220 is on a separate device, when data in global memory 220 is needed by processor engine 202, a request for the data is made by memory interface 216. Memory interface 216 typically reads and writes data for other clients, including other circuits in PPU 122, as well. Because of this, a read request by the parallel processing unit may be delayed behind other requests. Also, data retrieval from an external memory such as global memory 220 is much slower than data retrieval from on-chip memory such as global register file 206. This leads to comparatively long delays, referred to as latency delays, when data is read from global memory 220. For this reason, it is desirable for threads to store data on-chip in global register file 206 during execution.

After a thread (or an entire CTA), has been executed, the thread's space in global register file 206 needs to be freed up so it can be allocated for use by subsequent thread arrays. Before terminating, the threads can write any data stored in global register file 206 to global memory 220 via memory interface 216.

In computations where some or all or the data read from global memory 220 for a CTA is needed by the CTA at a later time, it is desirable to maintain this data, i.e., the “reusable” data, on chip, thereby avoiding the latency delay incurred by reading the data back from global memory 220. Accordingly, some embodiments of the present invention reduce memory bandwidth usage by caching data read from an external memory for a CTA that can also be used later by the CTA in an on-chip memory.

### Binomial Options Pricing Model Computations Using a Parallel Processor

Various time domain algorithms can be executed using cooperative thread arrays, such as binomial options pricing model computations. In finance, the binomial options pricing model provides a numerical method for the valuation of options. The binomial options pricing model uses a discrete-time framework to trace the evolution of an option's key underlying variable (e.g., the value of the option) via a lattice for a given number of time steps between valuation date and option expiration. Each node in the lattice represents a possible price of the underlying option at a particular point in time. This price evolution forms the basis for the option valuation.

The lattice of prices is produced by working forward from valuation date to expiration. An initial array of n+1 nodes node₀[i] is time-evolved through a number n of time steps. At each time step, it is assumed that the price of the underlying instrument will increase or decrease by a specific factor (“up” factor u or “down” factor d) that is the same for each time step. By definition, u≧1 and 0<d≦1. If S is the current price, then in the next time period the price will either be Sᵤₚ=S·u, or S_{down}=S·d. The up and down factors are calculated using the underlying volatility (σ), and the time duration (τ) of each time step measured in years. Specifically, u and d are defined as follows:

$$\begin{matrix}u = {e}^{σ \sqrt{τ}} & ( Eq . 1 ) \\ d = \frac{1}{u} & ( Eq . 2 )\end{matrix}$$

Using a call option as an example, each of the n+1 nodes in the lattice is initialized with a starting-time (t+0) value as follows:

nodeₜ₌₀[i]=max(0, S*u^{2t-n}−X) (Eq. 3)

where i=0 to n, S is the purchase price of the option and X is the strike price (i.e., the price at which the stock may be purchased in the future). At each time step (t) in the total number n of time steps, the nodes nodeₜ[i] for i=0 to n-t are updated using the formula:

$${node}_{t + 1} [ i ] = \frac{( p * {node}_{t} [ i + 1 ] + ( 1 - p ) * {node}_{t} [ i ] )}{R} \qquad ( Eq . 4 )$$

where R is the risk-free rate of compounded interest per time step, and

$$p = \frac{R - d}{u - d} \qquad ( Eq . 5 )$$

As can be seen from the above formula, a node value nodeₜ₊₁[i] at time step t+1 is dependent on the same node at the previous time step (nodeₜ[i]) and an adjacent node at the previous time step (nodeₜ[i+1]). Ultimately, this produces a final node that is the expected value of the option at the expiration date. In other words, after the nth time step node[0] contains the final option value. Thus, at each successive time step, one fewer node is needed. At any intermediate time, the value of the option is the value of node[0] at that time step.

In accordance with an embodiment of the present invention, one or more CTAs can be used to compute expected values of options using the binomial options pricing model. One or more CTAs could be used to compute the new node values at each time step, with the number of CTAs needed per time step gradually decreasing. However, each CTA would need to write its output node values to global memory 220 so that a later CTA could read them back to shared memory 206, which can introduce significant latency delays.

The latency delays can be reduced by having each CTA compute multiple time steps before storing intermediate results in global register file 206. In one embodiment, each CTA computes a number k of time steps for a swath of m adjacent nodes (where m≦k). That is, the CTA will compute nodes nodeₜ₀₊₁[i] to nodeₜ₀₊ₖ[i] for m nodes i. To perform this computation, the CTA reads in m+k node values nodeₜ₀[i] from global memory 220, which provides enough data to compute m nodes at time step t0+k.

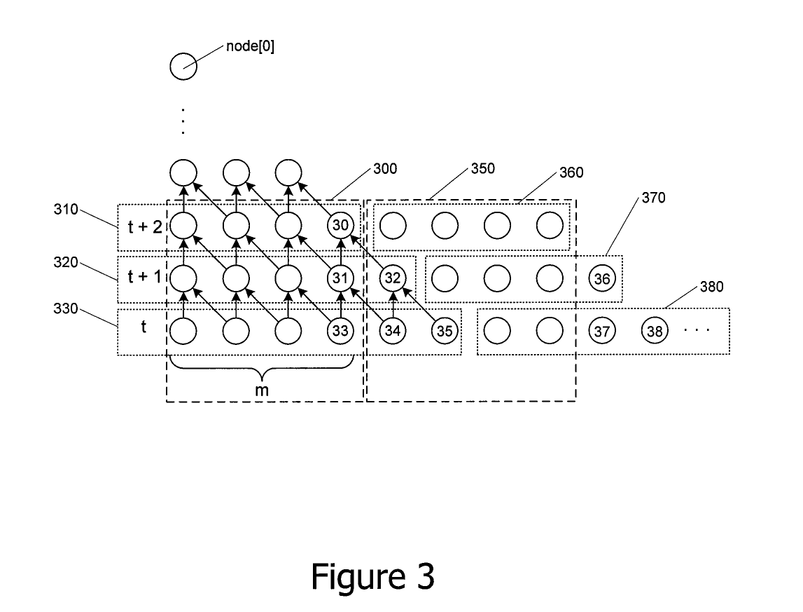

FIG. 3 illustrates portions of a lattice of data generated during binomial options pricing model computations according to an embodiment of the present invention. Each circle corresponds to a node value of the lattice. Node values in one swath 300 of the lattice may be processed using a cooperative thread array. Node values in an adjacent swath 350 of the lattice may be concurrently processed using a cooperative thread array operating in parallel.

At time step t, the bottom row of nodes, including node groups 330 and 380, are the initial n+1 nodes that are populated. These nodes are populated using Eq. 3 above when the time step t is time t=0. If not starting from t=0, the values are computed in a previous swath and would be loaded into shared memory by the CTA (as explained below). The bottom row could extend farther to include additional nodes. Computations are performed for the next time step (t+1) using the nodes at the previous time step (time step t) to generate the nodes in groups 320 and 370. After the nodes are computed for time step t+1 is done, the nodes for the next time step (t+2) are generated for groups 310 and 360. In short, nodes are generated in a pyramid from bottom to top.

The CTA works in swaths of m nodes and k time steps (e.g., swaths 300, 350). In one embodiment, each CTA includes a number of threads (e.g., 64, 128 or 192). Different computations are allocated among the threads to generate a number of nodes in parallel. In one embodiment, m+k−1 threads are allocated, with some threads becoming idle once the corresponding node is updated. In another embodiment, m threads are used for performing the computations, with up to k−1 of the threads computing a second node at a given time step. In one embodiment, the value of n is between 100 and 1000, m is proportional to the size of the space in global register file 206 that is available to the CTA (e.g., 512), and k may be calculated empirically from m and the number of threads.

As shown in FIG. 3, m=4 and k=2. At time step t=0, the CTA generates the m+k=6 initial values in group 330. If t≠0, the values in group 330 are the result of a previous swath, and the CTA reads the values from global memory 220. The CTA proceeds to compute the nodes in group 320, writing the results to global register file 206. The CTA computes the nodes in group 310, again writing the results to global register file 206. The CTA writes the m=4 nodes in group 310 from global register file 206 to global memory 220 to complete the node computations for swath 300. All of the space in global register file 206 that was used for nodes in swath 300 can be freed up so that the CTA can use that space to generate nodes for swath 350. After generating nodes for all swaths needed for time steps up to t+2, the CTA returns to the first swath for time step t+3. The process continues until time step n is reached, where there is only one node (e.g., node[0]). Thus, memory latency is avoided by computing nodes at multiple time steps between global memory writes.

Additional memory latency is avoided by saving nodes in on-chip memory that are used in computations for more than one node. For example, nodes 32, 34 and 35 are generated while processing swath 300, but are also needed for swath 350. In one embodiment, a CTA generates nodes 32, 34 and 35 while processing swath 300, then saves those values in local register file 204 when swath 300 is complete. When the CTA proceeds to swath 350, it loads the values for nodes 32, 34 and 35 back into global register file 206 to avoid having to compute them again.

In another embodiment, two different CTAs may operate in parallel to generate nodes in different swaths, e.g., swaths 300 and 350. In this embodiment, both CTAs will compute nodes 32, 34, and 35, although the values will be identical.

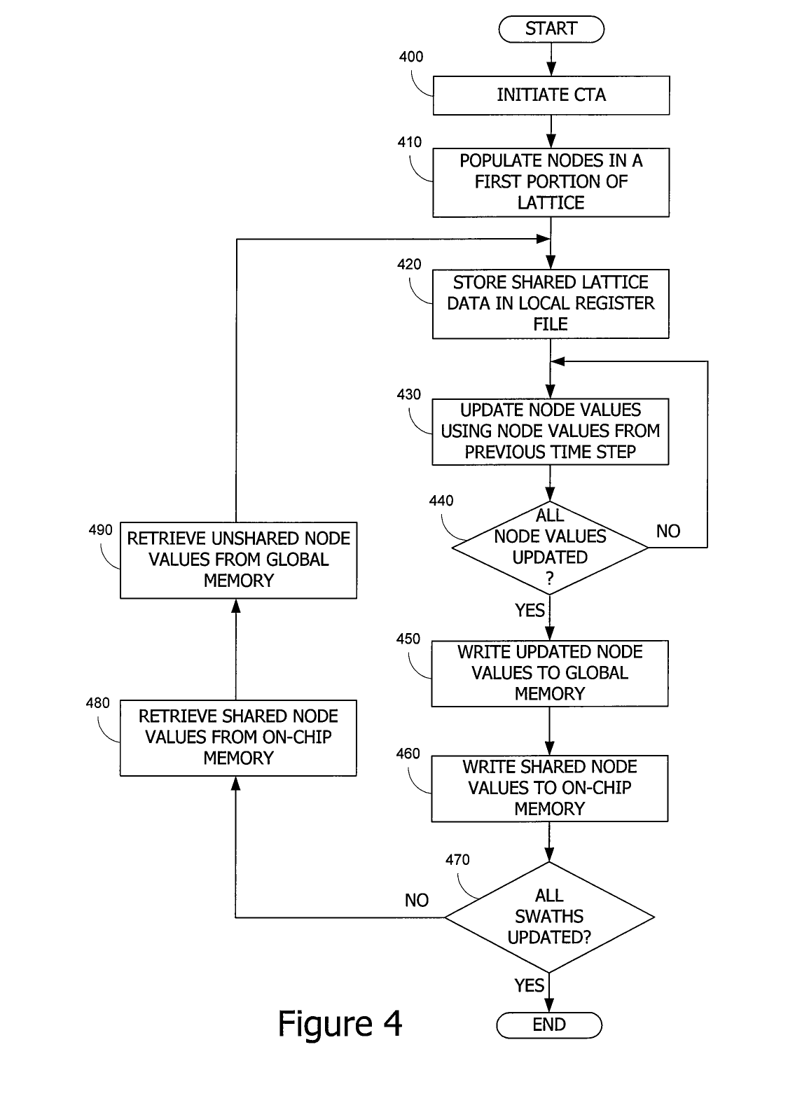

FIG. 4 illustrates a method for performing binomial options pricing model computations on a lattice of data according to an embodiment of the present invention. In operation 400, a CTA is initiated. In operation 410, nodes in a first portion of the lattice are populated using Eq. 3 above. Rather than reading all of the node values for each time step, the node values for a given time step are divided into multiple swaths of nodes for each time step as described above.

Lattice data that is common to the first portion and a second subsequent portion of the lattice (e.g., nodes 34 and 35 in FIG. 3) is stored in local register file 204 in operation 420. At operation 430, the binomial options pricing model computations are performed for a number of time steps to update the node values in global register file 206 using node values from a previous time step. Specifically, the node value at a given time step is dependent on the node value at the previous time step and the value of an adjacent node at the previous time step. The number of node values generated at each time step is one node less than the previous time step, as described above.

At operation 440, it is determined whether all m node values for all k time steps have been updated for the current swath. If not, the updating continues at operation 430. When complete, the node values for time step t₀₊ₖ are written out to global memory at operation 450. Intermediate node values that are shared with an adjacent swath that has not yet been processed (e.g., node 32 in FIG. 3) are written to an on-chip memory (e.g., local register file 204) at operation 460. At operation 470, it is determined whether all swaths have been updated. If not, then node values that were stored in local register file 204 (e.g., 32, 34, 35) are retrieved at operation 480, and additional node values (e.g., group 380) are retrieved from global memory 220 at operation 490. The process returns to operation 420, where a part of the new data that is common to a third subsequent lattice portion adjacent to the second lattice portion (e.g., nodes 37, 38) is stored in local register file 204. If it is determined in operation 470 that all node values in the lattice have been updated, then processing is complete. Processing for subsequent time steps may proceed if desired, e.g., by launching a new CTA to perform the next k time steps.

It will be appreciated that the process shown in FIG. 4 is illustrative and that variations and modifications are possible. Steps described as sequential may be executed in parallel, order of steps may be varied, and steps may be modified or combined.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

While the invention has been described with respect to specific embodiments, one skilled in the art will recognize that numerous modifications are possible. The scope of the invention should, therefore, be determined with reference to the appended claims along with their full scope of equivalents.

What is claimed is:

1. A method for performing binominal options pricing model computations on a set of node values, the method comprising:
reading a first swath of the set of node values from an external memory, wherein the first swath of node values comprises a first portion of node values for which binomial options pricing model computations are to be performed and a second portion of node values for performing the binomial options pricing computations on the first portion of node values;
executing binomial options pricing model computations on the first portion of node values using the second portion of node values to generate a set of results, wherein the binomial options pricing model computations are executed for a plurality of time steps; and
storing the set of results in an external memory.

2. The method of claim 1 wherein executing binomial options pricing model computations further comprises: for each node value, updating the node value using the corresponding node value at a previous time step and an adjacent node value at the previous time step.

3. The method of claim 1 wherein the binomial options pricing model computations are executed in a single-instruction, multiple data processing core.

4. The method of claim 1 wherein the binomial options pricing model computations are performed by a cooperative thread array.

5. The method of claim 1 further comprising initializing the node values in the external memory.

6. A method for performing binominal options pricing model computations on a set of node values, the method comprising:
reading a first subset of the set of node values from an external memory, wherein the first subset of node values comprises a first portion of node values for which binomial options pricing model computations are to be performed and a second portion of node values for performing the binomial options pricing computations on the first portion of node values;
storing the first subset of node values in an on-chip shared memory;
storing the second portion of the first subset of node values in an on-chip local memory;
executing binomial options pricing model computations on the first portion of node values using the second portion of node values to generate a set of results;
storing the set of results in the external memory;
loading the second portion of the first subset of node values from the on-chip local memory to the on-chip shared memory;
reading a second subset of the set of node values from the external memory, wherein a portion of the second subset of node values comprises a third portion of node values for which binomial options pricing model computations are to be performed, the second subset of node values further comprising a fourth portion of node values for performing the binomial options pricing computations on the third portion of node values;
storing the second subset of node values in the first on-chip memory; and
executing binomial options pricing model computations on the third portion of node values using the fourth portion of node values.

7. The method of claim 6 wherein storing the first subset of node values in an on-chip shared memory comprises storing the first subset of node values in an on-chip global register file.

8. The method of claim 6 wherein the binomial options pricing model computations are executed in a single-instruction, multiple data processing core.

9. The method of claim 6 wherein the binomial options pricing model computations are performed by a cooperative thread array.

10. The method of claim 6 further comprising initializing the node values in the external memory.

11. The method of claim 6 wherein executing binomial options pricing model computations further comprises: for each node value, updating the node value using the corresponding value at a previous time step and an adjacent node value at the previous time step.

12. The method of claim 6 wherein the on-chip shared memory and the on-chip local memory are included in a graphics processor.

13. A method of performing a binomial options pricing model computations on a lattice of data, the method comprising:
reading a first portion of the lattice from an external memory, storing the first portion of the lattice in a shared memory, and storing a subset of the first portion of the lattice in a local memory, wherein the first portion of the lattice comprises a first portion of node values for which binomial options pricing model computations are to be performed, the subset of the first portion of the lattice comprising a second portion of node values for performing the binomial options pricing model computations on the first portion of node values and also on a second portion of node values;
executing a first plurality of threads to perform binomial options pricing model computations on the first portion of node values to generate a set of results;
storing the results in the shared memory;
transferring the results from the shared memory in the external memory;
transferring the subset of the first portion of the lattice from the local memory to the shared memory;
reading a second portion of the lattice from the external memory;
storing the second portion of the lattice in the shared memory; and
executing a second plurality of threads to perform the binomial options pricing model computations on the second portion of the lattice and the subset of the first portion of the lattice.

14. The method of claim 13 further comprising executing the first plurality of threads and the second plurality of threads in a single-instruction, multiple data processing core.

15. The method of claim 13 wherein the shared memory is a global register file.

16. The method of claim 13 wherein the method is performed by a graphics processor.
